(19) United States
(12) Patent Application Publication
(10) Pub. No.: US 2026/0057776 A1
(43) Pub. Date: Feb. 26, 2026

(54) TRAFFIC PARTICIPANT ALERT COMPLEX FOR PREVENTING THEIR COLLISIONS

(71) Applicant: Titov Artem Valerevich, Moscow (RU)

(72) Inventor: Titov Artem Valerevich, Moscow (RU)

(21) Appl. No.: 19/218,821

(22) Filed: May 27, 2025

(30) Foreign Application Priority Data
Aug. 21, 2024 (RU) 2024124408

(51) Int. Cl. G08G 1/16; G06V 20/54; H04N 7/18

(52) U.S. Cl. CPC G08G 1/166; G06V 20/54; H04N 7/183

(57) ABSTRACT

The invention relates to systems for controlling road vehicles using reflection or re-emission of electromagnetic waves, for example, lidar systems, for warning or preventing collisions of ground vehicles.

The traffic participant alert complex for preventing their collisions consists of a driver information system, a road situation recognition and fixation system, a data radio exchange system, a power supply system, a data processing processor, a GSM module, a control processor, and a remote server.

The use of the claimed traffic participant alert complex for preventing their collisions expands the functionality of road infrastructure elements, improves road safety, and creates potential for further use of road situation data.

### TECHNICAL FIELD

The invention pertains to systems for controlling road vehicles that use reflection or re-emission of electromagnetic waves, for example, lidar systems, for warning or preventing collisions of ground vehicles

### BACKGROUND OF THE INVENTION

Numerous technical solutions are known from the state of the art, intended to alert traffic participants about the approach of an oncoming vehicle in order to prevent a collision, particularly when performing an overtaking maneuver in the oncoming lane.

The most common and relevant technical solutions in this field as of today are intelligent systems (devices) installed on a vehicle and/or using a wireless network. For example, such technical solutions are described in invention patents RU2715601 dated 2 Mar. 2020, RU2756878 dated 6 Oct. 2021, Chinese application CN110053608A dated 26 Jul. 2019, U.S. Pat. No. 11,615,700B2 dated 28 Mar. 2023, Chinese application CN109910875A dated 21 Jun. 2019.

The disadvantages of the described systems include their operability being dependent on the condition of users'(drivers') mobile devices or on the functioning of wireless networks.

A system for alerting road users about danger is known from the state of the art, presented in U.S. Pat. No. 10,235,882B1 dated 19 Mar. 2019. The mentioned system includes at least one device (RSE) containing a housing made with the possibility of mounting on an element of road infrastructure, motion sensors (101), such as ultrasonic sensors and/or lidars, a fixation module (101) in the form of video or photo cameras, a data transmission module (104) with external software (130), a processor (105) made with the possibility of receiving and processing data coming from the elements included in the construction of the device, as well as from other similar devices of the system. The device also includes a connector (108) for connection with a danger alert module (for example, in the form of a traffic light).

A system for alerting road users about danger is also known from the state of the art, described in international application WO2022144744A1 dated 7 Jul. 2022. The alert system includes at least two devices, each of which contains a housing made with the possibility of mounting on an element of road infrastructure, at least one motion sensor (ultrasonic or lidar), a processor made with the possibility of determining the location of a vulnerable road user and determining the direction of movement of the vulnerable road user, wherein the processor of each device is configured to send the first independent message to at least one device; the processor is configured to determine which device receives the independent message based on the location and direction of movement of the vulnerable road user received from the devices that are part of the system; an alert module made with the possibility of outputting a visual display and/or sound signal, a radio receiver and a radio transmitter, a power supply module.

Also known from the state of the art is the technical solution described in Chinese application CN111223299A dated 2 Jun. 2020. The overtaking control system based on an intelligent lamp post includes a processor made with the possibility of determining the position of a vehicle, predicting its route, speed, overtaking index based on the speed of the vehicle ahead, which the vehicle follows, and the average speed of the vehicle ahead, the overtaking distance of the vehicle ahead in the current lane; calculating the overtaking safety coefficient based on the speed of the vehicle behind in the overtaking lane and the remaining overtaking distance of the vehicle ahead in the current lane; making a decision to prohibit or allow performing a safe overtaking maneuver.

A common disadvantage of the described systems is dependence on centralized wireless communication networks, through which, via the data transmission module, information about the road situation is sent and after processing by external software, a command is sent to warn road users about a possible collision hazard. Centralized wireless communication networks may have unstable operation, caused, for example, by signal jamming with special technical means during various combined-arms operations or unstable operation of switching equipment of cellular network operators.

In addition, one can note the low reliability of operation and incorrect informing of road users in the event of a failure of the main processor, which negatively affects road safety.

The closest analogue of the considered technical solution can be considered the technical solution described in U.S. Pat. No. 11,370,440B2 dated 28 Jun. 2022.

The system for alerting road users about an idealized overtaking maneuver consists of at least two devices (201, 202, 203) located on both sides of vehicle movement, each of which includes a housing made with the possibility of mounting on a road infrastructure element, including a motion sensor (ultrasonic or lidar), a surrounding environment fixation module, a processor (evaluation unit) made with the possibility of determining the future environment of the vehicle, a data transmission module, a power supply module, devices (110) including a central processor (100) made with the possibility of receiving and processing data about the speed and position of vehicles coming from the devices that are part of the system (201, 202, 203), calculating the speed of vehicles and constructing the trajectory of safe overtaking of a vehicle, an alert module made with the possibility of visual display output, a module made with the possibility of remote data exchange with external software, and a power supply module.

The described prior art shows the absence of direct analogues of the claimed device and the need to develop a traffic participant alert complex for preventing their collisions with expanded functionality, increased reliability, and independence from centralized communication networks.

### SUMMARY OF THE INVENTION

Existing similar systems for alerting road users have a number of disadvantages. The basis of these disadvantages is their dependence on centralized wireless communication networks or user devices, which, for various reasons, may operate unstably.

Also, a significant disadvantage is the low reliability and inaccurate alerts in the event of a failure of the main processor, which negatively affects road safety.

The technical result achieved by the claimed device consists in providing local or autonomous driver alerting to prevent head-on vehicle collisions directly at the location of the claimed complex, through the use of a data radio exchange system with an internal encrypted radio channel for information exchange between the elements of the claimed complex and a driver information system with a stationary information display screen.

The claimed complex is not tied to centralized wireless communication networks, the blocks of the device interact with each other via an internal encrypted radio channel without the participation of a remote server, and the warning is displayed on a screen near the monitored road environment.

Also, the claimed complex has increased reliability due to the presence of an additional control processor, which, in the event of a failure of the main data processing processor, duplicates all of its critical functions.

The technical result is achieved through a traffic participant alert complex for preventing their collisions, which consists of an information system with a screen, a road situation recognition and fixation system based on a distance sensor and a video sensor, a data radio exchange system, a GSM module, a remote server, a power supply system, a data processing processor configured to receive and process data on the speed and position of vehicles, calculate vehicle speed, and analyze the safe overtaking trajectory of at least one of the vehicles,
characterized in that the data processing processor is configured to initiate commands for the information system via an internal secure radio channel by means of the data radio exchange system and includes a control processor configured to monitor the functioning of the data processing processor and duplicate its functions;
the information system includes an audible alert element;
the data processing processor is configured to read data from the data radio exchange system, generate warning images for output to the screen and audible alerts for the information system, process, transmit and receive data and commands to the GSM module for exchange with the remote server, monitor the parameters of the power supply system;
the power supply system is implemented based on rechargeable batteries, photovoltaic converters, wind generators, and a diesel substation.

The use of the claimed traffic participant alert complex for preventing their collisions expands the functionality of road infrastructure elements, increases road safety, and creates potential for further use of road situation data.

### BRIEF DESCRIPTION OF DRAWINGS

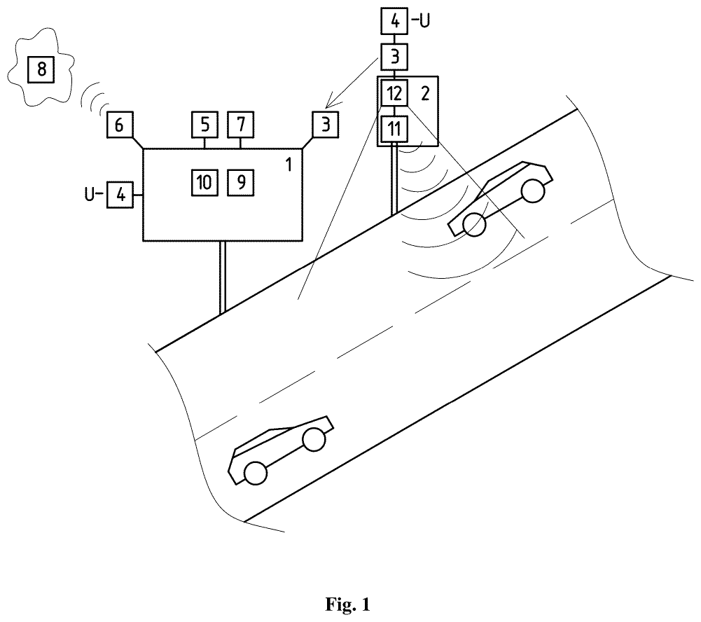

In FIG. 1, an example of implementation of the claimed traffic participant alert complex for preventing their collisions is illustrated.

### DETAILED DESCRIPTION OF THE INVENTION

The traffic participant alert complex for preventing their collisions consists of:
driver information system 1,
road situation recognition and fixation system 2,
data radio exchange system 3,
power supply system 4,
data processing processor 5,
GSM module 6,
control processor 7,
remote server 8.

Driver information system 1 includes at least one screen 9 for reproducing static images with any kind of information or streaming video, and an audible alert element 10 for playing sound signals or various audio information.

In the case of a large length of the controlled road section or limited visibility, multiple claimed complexes may be used. These are coordinated via the data radio exchange systems 3 and GSM modules 6 of each complex to ensure synchronized operation of all data processing processors 5 and control processors 7 used in the complexes.

Road situation recognition and fixation system 2 contains distance sensor 11 and video sensor 12.

Distance sensor 11 is made in the form of a lidar or other electronic component capable of detecting the presence of an object and tracking its movement over time.

Video sensor 12 is a sensitive matrix for capturing and forming a video sequence of the surrounding environment within its field of view.

Data radio exchange system 3 consists of a radio receiver and a radio transmitter, which operate synchronously using a cryptographic encryption algorithm, for example, an asymmetric cryptographic encryption algorithm—RSA (abbreviation from Rivest, Shamir, and Adelman, the surnames of the algorithm's creators) and/or by means of symmetric encryption—AES (Advanced Encryption Standard).

The radio receiver and radio transmitter of system 3 allow receiving and transmitting information via radio waves.

Power supply system 4 supplies voltage to the power-dependent components of the claimed complex.

It can be implemented based on rechargeable batteries, photovoltaic converters, wind generators, or a diesel substation.

Data processing processor 5 is a microcontroller or single-board computer (for example, Raspberry Pi or Arduino) for data processing and device control, with memory (RAM and/or flash memory) for storing data and software.

It performs the following functions:
Calculation of the speed of an approaching object

Processor 5 receives data from distance sensor 11, which measures the distance to an approaching vehicle.

Based on timestamps and changes in distance, processor 5 calculates the speed of the approaching object.

Using the calculated speed, processor 5 predicts the time of arrival of the object to the next distance sensor 11.
Calculation of the speed of a receding object Processor 5 receives data from distance sensor 11, which measures the distance to a receding vehicle.

Based on timestamps and changes in distance, processor 5 calculates the speed of the receding object.

Using the calculated speed, processor 5 predicts the time of departure of the object from the current distance sensor 11.
Comparison of readings from at least two distance sensors 11, if available, to minimize errors and compare their performance indicators

Processor 5 compares data received from at least two distance sensors 11 to identify possible errors and inconsistencies.

Then processor 5 analyzes the difference in readings and determines possible sensor malfunctions.

For example, if the sensor 11 readings exceed physically permissible values, processor 5 initiates a command to check their operability.
Initiation of a command to the radio transmitter to send a signal to the radio receiver of system 3

Processor 5 generates commands for the radio transmitter of system 3 based on data analysis and the current road environment.

For example, the command may contain information about traffic density, speed of movement, and forecasted events.

Processor 5 initiates sending the generated signal to the radio receiver via the radio transmitter of system 3.
Reading data from the radio receiver of system 3 regarding the state of other elements of the complex

Processor 5 reads data received from the radio receiver of system 3 containing information from road situation recognition and fixation system 2.

Then the processor analyzes the received data to coordinate operation with other complexes similar to the claimed one.

The data may include information about the current road situation, incidents, and traffic forecasts.
Generating an image for display on screen 9

Processor 5 processes data to generate a visual representation of the road situation.

For example, graphs of traffic density, geographic maps of the area with indications of incidents and weather conditions.

Processor 5 generates images for display on screen 9 using libraries for graphical data visualization, for example, matplotlib or OpenGL.
Processing and transmission of data and commands to GSM module 6 for exchange with remote server 8

Processor 5 generates data packets for transmission to remote server 8 via GSM module 6.

For example, the data packet may include timestamps, location, traffic density data, and incident reports.

Processor 5 initiates transmission of the generated data packets to remote server 8 via GSM module 6.
Receiving and processing data and commands from GSM module 6 received from remote server 8

Processor 5 receives data and commands from remote server 8 via GSM module 6 and processes the received commands and data to execute corresponding actions.

For example, the commands may include instructions for changing device operating parameters or software updates.
Generating a command for audible alert

Processor 5 analyzes data to determine the necessity of an audible alert for road users.

For example, the audible alert may be initiated when an accident or heavy traffic is detected.

Processor 5 generates a command for the audible alert. The command may include the type of sound signal and duration.
Monitoring the parameters of power supply system 4 of the claimed device components

Processor 5 receives data on the power supply status of the complex.

The data may include voltage, current, and battery charge level.

Processor 5 analyzes this data to detect possible power supply problems.

For example, if the voltage drops below an acceptable level, the processor initiates a warning or switches to backup power.

Processor also predicts the power supply condition based on current and historical data, using machine methods of time series analysis to forecast battery operating time.

GSM module 6 serves to transmit data to remote server 8 via a cellular network.

Control processor 7 is a microcontroller or single-board computer (for example, Raspberry Pi or Arduino) for data processing and device control, with memory (RAM and/or flash memory) for storing data and software.

It performs verification of the operation of the claimed complex for compliance with specified algorithms, namely:
Processes information from data processing processor 5

Control processor 7 receives data from data processing processor 5.

For example, the data may include information on traffic density, speed of moving objects, road surface condition, and other parameters.

Control processor 7 performs preliminary data processing for further analysis.
Compares readings with the operating algorithm

Control processor 7 compares the received data with reference values and operating algorithms.

It also analyzes deviations to detect possible malfunctions in the operation of the claimed complex.
Sends data on complex stability readings to GSM module 6

Control processor 7 generates reports on the operational stability of the complex based on data analysis.

For example, the report may include information on the current state of the system, detected deviations, and corrective measures taken.

Then processor 7 sends the generated reports to GSM module 6 for transmission to remote server 8, using data transmission protocols such as MQTT or HTTP for sending the reports.
In case of malfunction of data processing processor 5, duplicates execution of its functions

Control processor 7 continuously monitors the state of processor 5 to detect possible failures.

In case failures are detected in processor 5, control processor 7 takes over the performance of its tasks.
Diagnostics and self-check

Control processor 7 performs regular self-checks to identify its own failures and malfunctions.

For example, it performs memory integrity checks and testing of basic functions.
Software updates

Control processor 7 receives software updates from remote server 8, using GSM module 6 to download the necessary updates.

Then processor 7 installs the received updates to ensure relevance and security of the claimed complex's operation.
Power consumption management

Control processor 7 monitors the complex's power consumption to optimize operation.

For example, it collects data on power consumption, voltage, and current, and takes measures to optimize energy use, such as disconnecting unused modules from power supply.

All the listed functions of control processor 7 together ensure high reliability and efficiency of the claimed complex.

Remote server 8 is server equipment (for example, a server based on x86 or ARM architecture) for processing and storing data received via GSM module 6.

Remote server 8 contains server software for data management, analysis and visualization of information, and also implements a backup function to ensure data preservation.

To prevent collisions between vehicles and other road users during overtaking, the elements of the claimed complex are installed on road infrastructure structures, for example, on a lamp post or on a special truss resembling a billboard, which are placed on the sides of roads or near pedestrian crossings (see FIG. 1). When power is supplied from a power source, the power-dependent elements of the claimed system are activated, and it switches to standby mode. At the same time, distance sensor 11 continuously scans the area of its operation. In the event that moving objects are detected in the area of its operation, distance sensor 11 generates data on the speed and direction of movement of these objects and transmits this information using the radio transmitter of system 3, and processor 5 receives this information via the radio receiver of system 3. Processor 5 analyzes the received data using a special machine algorithm and, as a result, determines the probability of collision of moving vehicles in the area of operation of sensor 11. In case of a high probability of collision, processor 5 sends a warning command to inform road users of the danger, by displaying information on screen 9 about the speed of movement and playing a sound signal via audible alert element 10. Such audiovisual warning prompts road users to take timely actions to avoid a collision. At the same time, processor 5 additionally receives from the radio receiver of system 3 the video feed of the surrounding environment within the field of view of video sensor 12, which coincides with the area of operation of distance sensor 11. After the vehicles leave the area of operation of distance sensor 11 or if processor 5 determines the probability of collision to be low, the claimed complex returns to standby mode with the algorithm of operation described above. GSM module 6 allows the transmission of the saved video feed and information on the condition of sensor 11 to remote server 8 for review by interested parties or to receive commands for remote diagnostics and servicing of elements of the claimed complex.

Examples of Possible Scenarios of Vehicle Behavior and Actions of the Local Driver Alert Complex

Scenario “Normal movement without risk of collision”:

Vehicles move in their lanes, observing traffic rules. A safe distance is maintained between them.

Actions of the complex:
Distance sensor 11 and video sensor 12 detect the movement of vehicles and transmit data to data processing processor 5;
Processor 5 analyzes the data and determines that the probability of collision is low;
The complex remains in standby mode, without activating the alert.

Scenario “Dangerous convergence of vehicles”:

Two vehicles move towards each other in one lane, creating a risk of collision.

Actions of the complex:
Distance sensor 11 detects dangerous convergence of vehicles and transmits data to data processing processor 5;
Processor 5 analyzes the data and determines a high probability of collision;
Processor 5 sends a command to screen 9 and audible alert element 10 to activate visual and audio warnings for road users;
Road users receive the warning and take action to prevent a collision (for example, reduce speed or return to their lane).

Scenario “Overtaking in the oncoming lane”:

A vehicle begins overtaking, moving into the oncoming lane, while another vehicle is approaching.

Actions of the complex:
Distance sensor 11 detects the vehicle entering the oncoming lane and the approaching oncoming vehicle;
Data processing processor 5 analyzes the data and determines the probability of collision;
If the probability of collision is high, processor 5 sends a command to screen 9 and audible alert element 10 to activate driver warnings;
Drivers receive the warning and take action to prevent a collision (for example, the overtaking vehicle returns to its lane).

Scenario “Obstacle on the road”:

An obstacle appears on the road (for example, a broken-down vehicle or a fallen tree), which creates a threat for moving vehicles.

Actions of the complex:
Video sensor 12 detects the presence of an obstacle and transmits data to data processing processor 5;
Processor 5 analyzes the data and identifies a threat to moving vehicles;
Processor 5 sends a command to screen 9 and audible alert element 10 to activate a warning to drivers about the obstacle on the road;

- Drivers receive the warning and take action to bypass the obstacle or stop.

Scenario “Unstable system operation”:

One of the components of the complex (for example, sensor 11 or processor 5) begins to operate unstably or fails.

Actions of the complex:
Control processor 7 receives data about instability from data processing processor 5;
Control processor 7 analyzes the data and determines the need for intervention;
Control processor 7 takes over the tasks of data processing processor 5 and sends fault information to GSM module 6;
GSM module 6 sends the fault data to remote server 8 for further analysis and measures to eliminate the malfunction.

Scenario “Traffic flow regulation during roadwork”:

Roadwork is being carried out on a section of the road, and it is necessary to regulate traffic flow to prevent congestion and accidents.

Actions of the complex:
Distance sensor 11 and video sensor 12 detect vehicle movement towards the repaired road section and transmit data to data processing processor 5;
Processor 5 analyzes the data and determines the number of vehicles approaching the repaired section from each direction;
The complexes exchange data through transmitters and receivers of data radio exchange system 3 for coordinated actions;
One of the complexes activates screen 9 and audible alert element 10 to permit the passage of vehicles from one side;
The complex on the opposite side activates screen 9 and audible alert element 10 to prohibit passage of vehicles from the opposite side;
After completion of the passage of vehicles from one direction, data processing processor 5 initiates a change in the direction of movement.

Scenario “High road congestion”:

A section of the road experiences high vehicle congestion, which may lead to traffic jams and emergency situations.

Actions of the complex:
Distance sensor 11 and video sensor 12 detect high road congestion and transmit data to data processing processor 5;
Processor 5 analyzes the data and determines the need to inform drivers about the congestion;
Processor 5 sends a command to screen 9 to display information about road congestion and possible detour routes;
Drivers receive the information and can make a decision to change their route to bypass traffic jams.

The provided examples of possible scenarios of operation of the claimed complex demonstrate how various elements of the complex respond to emerging situations on the road, providing timely warnings and improving road safety.

Examples of Possible Data Exchange Scenarios of the Claimed Complex with the Remote Server

Scenario “Regular transmission of system status data”:

The local complex regularly sends data on its status to the remote server for monitoring and analysis.

Actions of the complex:
Data processing processor 5 collects information on the condition of all components of the complex (for example, battery charge level, sensor and processor operability);
GSM module 6 receives this data from data processing processor 5;
GSM module 6 sends the data to remote server 8;
Remote server 8 receives the data and saves it for further analysis and monitoring.

Scenario “Transmission of road situation data”:

The local complex sends data on the current road situation to the remote server for analysis and decision-making.

Actions of the complex:
Distance sensor 11 and video sensor 12 detect the current road situation and transmit data to data processing processor 5;
Data processing processor analyzes the data and forms a report on the road situation;
GSM module 6 receives the report from the data processing processor;
GSM module 6 sends the report to remote server 8;
Remote server 8 receives the data and uses it to analyze the road situation and make decisions (for example, notifying other drivers or services).

Scenario “Receiving commands for software update”:

The remote server sends a command to the local complex to update the software.

Actions of the complex:
Remote server 8 generates a software update command and sends it to GSM module 6 of the claimed complex;
GSM module 6 receives the command and transmits it to data processing processor 5;
Data processing processor 5 initiates the software update process, downloads the necessary files, and restarts the system after the update is completed.

Scenario “Transmission of malfunction data”:

The local complex detects a malfunction and sends data about it to the remote server for diagnostics and corrective measures.

Actions of the complex:
Control processor 7 detects a malfunction in one of the components of the complex;
Control processor 7 transmits the malfunction data to GSM module 6;
GSM module 6 sends the malfunction data to remote server 8;
Remote server 8 receives the data and initiates the process of diagnosing and eliminating the malfunction (for example, sending a restart command or replacing the component).

Scenario “Receiving commands to change settings”:

The remote server sends a command to the local complex to change settings (for example, changing the alert trigger threshold).

Actions of the complex:
Remote server 8 generates a settings change command and sends it to GSM module of the local complex;
GSM module 6 receives the command and transmits it to data processing processor 5;
Data processing processor 5 changes the settings in accordance with the received command and confirms execution to remote server 8.

Scenario “Emergency data transmission”:

The local complex detects a critical situation (for example, a mass traffic accident) and sends data to the remote server for immediate response.

Actions of the complex:
Distance sensor 11 and video sensor 12 detect a critical situation and transmit data to data processing processor 5;
Data processing processor 5 analyzes the data and determines that the situation is critical;
GSM module 6 receives data about the critical situation from data processing processor 5;
GSM module 6 sends the data to remote server 8 with high priority;
Remote server 8 receives the data and initiates emergency measures (for example, notification of emergency services and other drivers).

The provided examples of scenarios demonstrate how the claimed complex interacts with remote server 8 to ensure effective monitoring, management, and response to various road situations.

Examples of Statistical Road Situation Data Transmitted by the Claimed Complex to the Remote Server

The complex can transmit various statistical road situation data to remote server 8, which can be used for analysis and forecasting, for example:
Traffic density: the number of vehicles on a specific road section per unit of time;
Speed of movement: the average speed of vehicles on a specific road section;
Delay time: the average delay time of vehicles on a specific road section;
Incidents and accidents: the number and types of incidents (accidents, breakdowns, roadworks, etc.);
Road surface condition: information on the condition of the road surface (presence of ice, snow, potholes, etc.);
Intersection and traffic light congestion: waiting time at intersections and traffic lights;
Pedestrian flow: the number of pedestrians on specific road sections.

The described statistical data can be processed on remote server 8 to build forecasts of the road situation using various data analysis and machine learning methods, for example:
Time series analysis: using time series analysis methods (for example, ARIMA, SARIMA) to forecast traffic density, speed of movement, and delay time based on historical data;
Machine learning: applying machine learning algorithms (for example, regression models, decision trees, neural networks) to forecast the road situation based on many factors (traffic density, weather conditions, incidents, etc.);
Geospatial analysis: using geospatial analysis methods to identify patterns and anomalies in the road situation on various road sections;
Simulation models: creating traffic simulation models to forecast the consequences of various events (for example, accidents, roadworks) on the road situation.

The data collected and processed on remote server 8 by the claimed complex can be used for traffic management, road infrastructure planning, improving road safety, for security and military purposes, for environmental monitoring, logistics, and the delivery of various cargoes.

1. A traffic participant alert complex for preventing their collisions, consisting of an information system with a screen, a road situation recognition and fixation system based on a distance sensor and a video sensor, a data radio exchange system, a GSM module, a remote server, a power supply system, a data processing processor configured to receive and process data on the speed and position of vehicles, calculate the speed of vehicles and analyze the safe overtaking trajectory of at least one of the vehicles, characterized in that the data processing processor is configured to initiate commands for the information system via an internal secure radio channel by means of the data radio exchange system and contains a control processor configured to monitor the functioning of the data processing processor and duplicate its functions.

2. The traffic participant alert complex for preventing their collisions according to claim 1, characterized in that the information system has an audible alert element.

3. The traffic participant alert complex for preventing their collisions according to claim 1, characterized in that the data processing processor is configured to read data from the data radio exchange system, generate warning images for output to the screen and audible alerts for the information system, process, transmit and receive data and commands to the GSM module for exchange with the remote server, and monitor the parameters of the power supply system.

4. The traffic participant alert complex for preventing their collisions according to claim 1, characterized in that the power supply system is implemented based on rechargeable batteries, photovoltaic converters, wind generators, and a diesel substation.
